(19) United States
(12) Patent Application Publication
(10) Pub. No.: US 2024/0118996 A1
(43) Pub. Date: Apr. 11, 2024

(54) ENTERPRISE DATA TEST AUTOMATION AS A SERVICE FRAMEWORK

(71) Applicants: Shrujan Jyotindrabhai Mistry, Harrisburg, NC (US); Renoi Thomas, Thornwood, NY (US)

(72) Inventors: Shrujan Jyotindrabhai Mistry, Harrisburg, NC (US); Renoi Thomas, Thornwood, NY (US)

(21) Appl. No.: 17/963,388

(22) Filed: Oct. 11, 2022

(51) Int. Cl. G06F 11/36

(52) U.S. Cl. CPC G06F 11/3688; G06F 11/3684

(57) ABSTRACT

Embodiments may provide systems and methods to facilitate automated testing for an enterprise data application layer. An Automated Testing Framework (“ATF”) platform may receive, from a user, data test planning information that defines a test case. The ATF platform may interpret Application Programming Interface (“API”) information to implement a Data Test Automation-as-a-Service (“DTAaaS”) and detect a trigger event that initiates a test execution associated with the test case. In some embodiments, information about the test case is stored via a third-party enterprise team planning system and/or hosting service for software development and version control. Responsive to the detected trigger, the ATF platform may automatically arrange to execute the test case via the DTAaaS. A test result of the executed test case may then be output (e.g., pass, fail, or inconclusive).

### BACKGROUND

In some cases, an enterprise may have a front-end application that access information in an enterprise data application layer via middle-ware. For example, an insurance company may have an application that retrieves and displays information about a set of customers (e.g., a customer first name, last name, home address, and age). Moreover, it may be desirable to test the operation of the enterprise data application layer to ensure that it is behaving as expected. For example, if a customer's age is shown as being “1,000” then information from the customer address might have been mistakenly accessed as the customer's age. To test the enterprise data application layer, a test case may be established along with rules to evaluate the test case (e.g., if a customer's age is greater than “120,” then the test case result may be set to “fail”). Manually creating and executing such test cases can be a time consuming and error-prone task—especially when a substantial number of applications and/or data elements may need to be monitored (e.g., an enterprise might have hundreds or thousands of such applications).

Systems and methods for improvements in processes to facilitate automated testing for an enterprise data application layer, including improved test case definition and execution, while avoiding unnecessary burdens on computer processing resources, would be desirable.

### SUMMARY OF THE INVENTION

According to some embodiments, systems, methods, apparatus, computer program code and means may provide ways to facilitate automated testing for an enterprise data application layer. An Automated Testing Framework (“ATF”) platform may receive, from a user, data test planning information that defines a test case. The ATF platform may interpret Application Programming Interface (“API”) information to implement a Data Test Automation-as-a-Service (“DTAaaS”) and detect a trigger event that initiates a test execution associated with the test case. In some embodiments, information about the test case is stored via a third-party enterprise team planning system and/or hosting service for software development and version control. Responsive to the detected trigger, the ATF platform may automatically arrange to execute the test case via the DTAaaS. A test result of the executed test case may then be output (e.g., pass, fail, or inconclusive).

Some embodiments provide means for receiving, from a user at a computer processor of an ATF platform, data test planning information that defines a test case; means for interpreting API information to implement a DTAaaS; means for detecting a trigger event that initiates a test execution associated with the test case; responsive to the detected trigger, means for automatically arranging to execute the test case via the DTAaaS; and means for outputting a test result of the executed test case.

A technical effect of some embodiments of the invention is an improved and computerized method to facilitate automated testing for an enterprise data application layer. With these and other advantages and features that will become hereinafter apparent, a more complete understanding of the nature of the invention can be obtained by referring to the following detailed description and to the drawings appended hereto.

### BRIEF DESCRIPTION OF THE DRAWINGS

FIG. 1 is block diagram of a system according to some embodiments of the present invention.

FIGS. 2A and 2B illustrate methods in accordance with some embodiments of the present invention.

FIG. 3 is an automated testing framework architecture according to some embodiments of the present invention.

FIG. 4 is a data testing process in accordance with some embodiments of the present invention.

FIG. 5 is a data test planning workflow according to some embodiments of the present invention.

FIG. 6 is a data test planning method in accordance with some embodiments of the present invention.

FIG. 7 is a test case upload display according to some embodiments of the present invention.

FIG. 8 is a test case upload notification message in accordance with some embodiments of the present invention.

FIG. 9 illustrates creation of a sample test case created from a bulk upload template according to some embodiments of the present invention.

FIG. 10 is a test execution workflow in accordance with some embodiments of the present invention.

FIG. 11 is a sample ATF job scheduler display according to some embodiments of the present invention.

FIG. 12 is a high-level process flow in accordance with some embodiments of the present invention.

FIG. 13 illustrates conversion of natural language direction into command line data according to some embodiments of the present invention.

FIG. 14 is a continuous testing workflow in accordance with some embodiments of the present invention.

FIG. 15 is a test execution method according to some embodiments of the present invention.

FIG. 16 illustrates ATF data reconciliation capabilities in accordance with some embodiments of the present invention.

FIG. 17 illustrates file feed validation according to some embodiments of the present invention.

FIG. 18 illustrates trend drift detection in accordance with some embodiments of the present invention.

FIG. 19 is a sample result created by an ATF according to some embodiments of the present invention.

FIG. 20 is an ATF defect management process in accordance with some embodiments of the present invention.

FIG. 21 is a test execution notification email message according to some embodiments of the present invention.

FIG. 22 is a test execution notification channel card according to some embodiments of the present invention.

FIG. 23 is a test execution report display according to some embodiments of the present invention.

FIG. 24 is a detailed report display in accordance with some embodiments of the present invention.

FIG. 25 is a historical trend display according to some embodiments of the present invention.

FIG. 26 is a trend display in accordance with some embodiments of the present invention.

FIG. 27 is a sprint display according to some embodiments of the present invention.

FIG. 28 is an adoption consistency display in accordance with some embodiments of the present invention.

FIG. 29 is a server usage display according to some embodiments of the present invention.

FIG. 30 is a team usage display in accordance with some embodiments of the present invention.

FIG. 31 is a MICROSOFT™ TEAM® integration adoption display according to some embodiments of the present invention.

FIG. 32 is an enterprise leaderboard display in accordance with some embodiments of the present invention.

FIG. 33 is block diagram of an ATF platform in accordance with some embodiments of the present invention.

FIG. 34 is a tabular portion of an ATF database according to some embodiments.

FIG. 35 illustrates a handheld tablet in accordance with some embodiments described herein.

### DESCRIPTION

Before the various exemplary embodiments are described in further detail, it is to be understood that the present invention is not limited to the particular embodiments described. It is also to be understood that the terminology used herein is for the purpose of describing particular embodiments only and is not intended to limit the scope of the claims of the present invention.

In the drawings, like reference numerals refer to like features of the systems and methods of the present invention. Accordingly, although certain descriptions may refer only to certain figures and reference numerals, it should be understood that such descriptions might be equally applicable to like reference numerals in other figures.

The present invention provides significant technical improvements to facilitate data availability, consistency, and analytics associated with enterprise data test automation. The present invention is directed to more than merely a computer implementation of a routine or conventional activity previously known in the industry as it provides a specific advancement in the area of electronic record availability, consistency, and analysis by providing improvements in the operation of a computer system that uses machine learning and/or predictive models to ensure data quality. The present invention provides improvement beyond a mere generic computer implementation as it involves the novel ordered combination of system elements and processes to provide improvements in the speed at which such data can be made available and consistent results. Some embodiments of the present invention are directed to a system adapted to automatically validate information, analyze electronic records, aggregate data from multiple sources including text mining, determine test results, etc. Moreover, communication links and messages may be automatically established (e.g., to provide test information reports and alerts), aggregated, formatted, exchanged, etc. to improve network performance (e.g., by reducing an amount of network messaging bandwidth and/or storage required to support test definition, collection, and distribution).

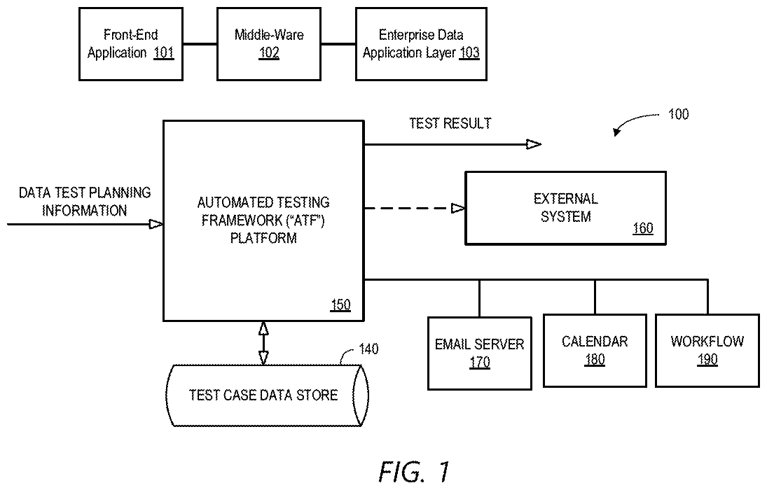

FIG. 1 is block diagram of a system 100 according to some embodiments of the present invention. The system 100 may be used to evaluate an enterprise data application 103 that is accessed by a front-end application 101 via middle-ware 102. In particular, the system 100 includes an ATF platform 150 that receives data test planning information (e.g., from an enterprise user). The ATF platform 150 might be, for example, associated with a Personal Computers (“PC”), laptop computer, an enterprise server, a web server farm, and/or a database or similar storage devices. The ATF platform 150 may, according to some embodiments, be associated with a business organization, such as an insurance provider. In some embodiments, the ATF platform 150 also receives third-party information (e.g., information about applications maintained by an enterprise).

According to some embodiments, an “automated” ATF platform 150 may facilitate generation of a test result (e.g., pass, fail, or inconclusive). As used herein, the term “automated” may refer to, for example, actions that can be performed with little or no human intervention. As used herein, devices, including those associated with the ATF platform 150 and any other device described herein, may exchange information via any communication network which may be one or more of a Local Area Network (“LAN”), a Metropolitan Area Network (“MAN”), a Wide Area Network (“WAN”), a proprietary network, a Public Switched Telephone Network (“PSTN”), a Wireless Application Protocol (“WAP”) network, a Bluetooth network, a wireless LAN network, and/or an Internet Protocol (“IP”) network such as the Internet, an intranet, or an extranet. Note that any devices described herein may communicate via one or more such communication networks.

The ATF platform 150 may also access a test case data store 140. The test case data store 140 might be associated with, for example, one or more trigger conditions that initiate a test. The test case data store 140 may be locally stored or reside remote from the ATF platform 150. As will be described further below, the test case data store 140 may be used by the ATF platform 150 to generate a test result. According to some embodiments, the ATF platform 150 communicates with an external system 160, such as by transmitting ATF information to an insurance provider platform, an email server 170 (e.g., to automatically establish a communication link based on ATF information), a calendar application 180 (e.g., to automatically create a reminder based on ATF information), a workflow management system 190, etc.

Although a single ATF platform 150 is shown in FIG. 1, any number of such devices may be included. Moreover, various devices described herein might be combined according to embodiments of the present invention. For example, in some embodiments, the ATF platform 150 and test case data store 140 might be co-located and/or may comprise a single apparatus.

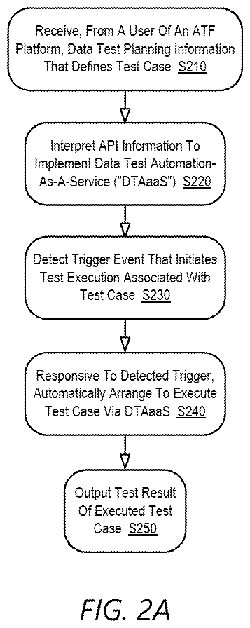

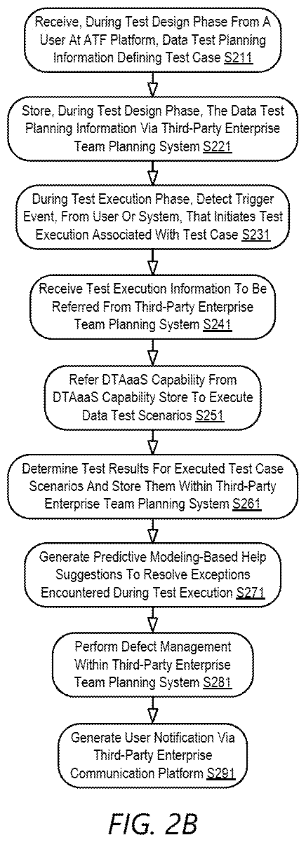

FIG. 2A illustrates a method that might be performed, for example, by some or all of the elements of the system 100 described with respect to FIG. 1 according to some embodiments of the present invention. The flow charts described herein do not imply a fixed order to the steps, and embodiments of the present invention may be practiced in any order that is practicable. Note that any of the methods described herein may be performed by hardware, software, or any combination of these approaches. For example, a computer-readable storage medium may store thereon instructions that when executed by a machine result in performance according to any of the embodiments described herein.

At S210, the system may receive, from a user at a computer processor of an ATF platform, data test planning information that defines a test case. The data test planning information might include, for example, information about test script design, test plan creation, a bulk upload template, a spreadsheet application record, a test locator, a test case name, a test case description, test case inputs, etc. At S220, the system may interpret Application Programming Interface (“API”) information to implement a Data Test Automation-as-a-Service (“DTAaaS”). According to some embodiments, information about the test case may be stored via a third-party enterprise team planning system such as RALLY® and/or a third-party hosting service for software development and version control such as GITHUB®. According to some embodiments, wherein information about the test case is automatically verified via the ATF API (e.g., a test environment, test parameters, or missing inputs). Moreover, a test case creation notification may be automatically transmitted to the user.

At S230, the system may detect a trigger event that initiates a test execution associated with the test case. The trigger event might comprise, for example, a standalone testing trigger, a command line interface trigger, a workload scheduler trigger, a third-party enterprise communication platform chat trigger, third-party enterprise team planning system trigger, a continuous testing trigger, an ATF API trigger, NLP, etc. Responsive to the detected trigger, the system may automatically arrange to execute the test case via the DTAaaS at S240. Arranging to execute the test case via the DTAaaS might include, for example, database conversion, file format conversion, data ingestion validation, file feed validation, table-to-table count validation, trend drift detection, JavaScript Object Notation (“JSON”) structure validation, data quality checks, data reconciliation across heterogeneous data platforms (including data stores and file systems), data profiling, etc. At S250, a test result of the executed test case (e.g., pass, fail, or inconclusive) may be output.

In this way, an ATF may provide Data Test Automation-as-a-Service (“DTAaaS”). At an enterprise, in-house test automation frameworks may be available for various layers of Information Technology (“IT”), such as front-end applications and middle-ware services. There is a need to have a framework that can be utilized by data projects across organization within the enterprise and across types of data projects (e.g., transactional processing databases, data warehouses, data marts, data lakes, or even file storage).

Note that for data projects, there may be many test scenarios, which if automated for one project, might be implemented in other projects across organizations without any (or very minimal) changes. Projects may need to maintain test plans, test cases, test results, and other testing related documentation on RALLY®. Hence, there may be a need for a framework to interacts with RALLY® automatically for the creation/update of test cases, uploading test results, and creating defects (if deemed necessary.) Different types of data assets may also create interest across projects where an ideal data test framework might be able to validate data residing into data stores such as ORACLE®, SQL Server, PostGre, SNOWFLAKE®, DB2 AS400, MySQL, or Big Data Hive Tables and various file formats such as XML, JSON, AVRO, PARQUET, etc. Moreover, a framework should be scalable in terms of adding support for new data asset types as well as adding new test automation capabilities to handle any future developments in the data space.

Some embodiments described herein provide a DTAaaS framework that allows for data test automation that lets projects maintain their test plans, test cases, test results, and other testing related documentation on RALLY® (bringing more transparency to overall data validation process). The concept of DTAaaS refers to the idea that data testing may be an automated capability that is called from ATF as (and when) needed across organizations by sending an ATF API request.

Data projects, in general, may have a standard set of data test scenarios, such as target data validations and data reconciliations, which may be automated through ATF. If any test scenario is not already automated (and a team creates their own automation), they can contribute the data test automation to the ATF under a framework capability called Bring Your Own Data Automation (“BYODA”). Once integrated with ATF, an entire enterprise can benefit from the automation, thus promoting inner sourcing with the organization. The ATF may provide a platform for all of the teams across an enterprise to utilize and contribute a well-managed data test automation eco-system (without duplicating effort by creating the same automation capability again).

FIG. 2B illustrates another method in accordance with some embodiments. At S211, the system may receive, during a test design phase from a user at a computer processor of an ATF platform, data test planning information that defines a test case. At S221, the system may store, during the test design phase, the data test planning information via a third-party enterprise team planning system (e.g., RALLY®).

At S231, the system may detect, during a test execution phase, a trigger event (from a user or a system) that initiates a test execution associated with the test case. At S241, the system may receive test execution information to be referred from the third-party enterprise team planning system. At S251, DTAaaS capability may be referred (from a DTAaaS capability store) to execute data test scenarios.

At S261, test results may be determined for the executed test case scenarios and storing them within the third-party enterprise team planning system. At S271, predictive modeling-based help suggestions may be automatically generated to resolve exceptions encountered during test execution. At S281, defect management may be performed within the third-party enterprise team planning system. At S291, the system may generate a user notification via a third-party enterprise communication platform (e.g., MICROSOFT™ TEAMS®).

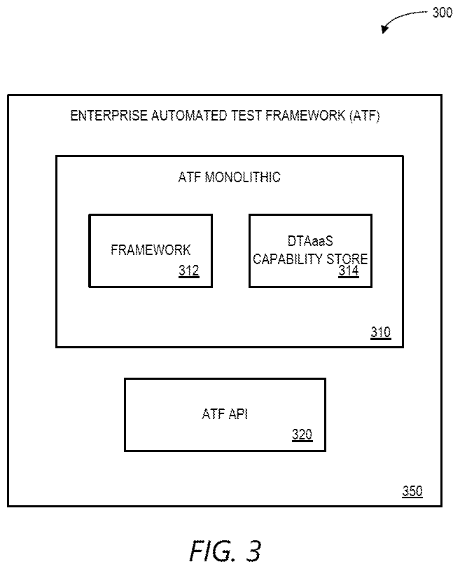

FIG. 3 is an automated testing framework architecture 300 according to some embodiments of the present invention. According to some embodiments, the architecture 300 is primarily a python-based enterprise ATF 350. The ATF 350 includes an ATF monolithic 310 comprising ATF monolithic code that sits on Linux servers and is backed by a Continuous Integration/Continuous Deployment (“CI/CD”) pipeline. The ATF monolithic 310 includes: (1) a framework 312 that interacts with all software delivery tools such as RALLY®, GITHUB®, MICROSOFT™ TEAMS®, OUTLOOK®, etc., and (2) a DTAaaS capability store 314 that holds the test automation capability for various scenarios.

The ATF 350 also include an ATF API 320 that provides an interface for test case uploads as well test execution triggers (e.g., via MS TEAMS® ChatOps, TALEND® joblet, etc.). The ATF API 320 also may also push event data into an ATF SNOWFLAKE® data store which is then utilized to populate test execution status and event tracking dashboards.

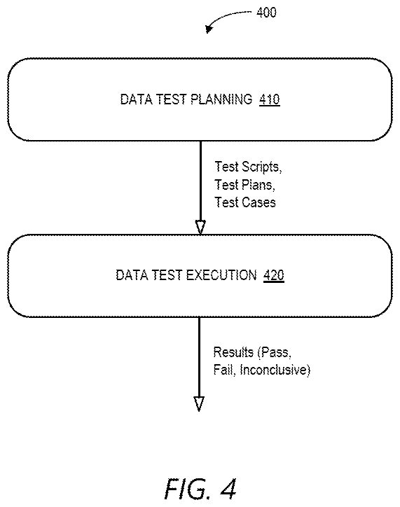

According to some embodiments, there are two major activities that are primarily involved with data testing. FIG. 4 is a data testing process 400 in accordance with some embodiments of the present invention. During data test planning 410, a user may design test scripts as well as create test plans and test cases. Data test execution 420 includes the execution of the test cases on data assets under test and retrieving results (e.g., pass, failed or inconclusive).

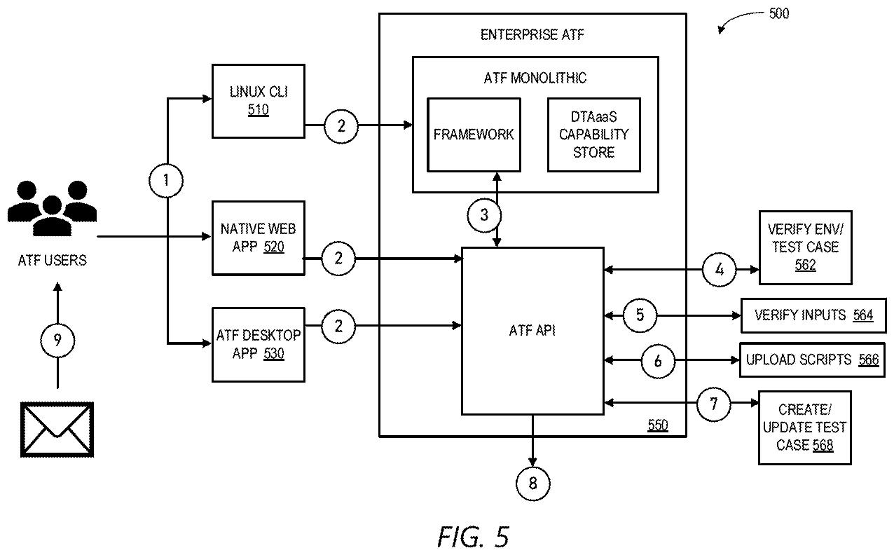

FIG. 5 is a data test planning workflow 500 according to some embodiments of the present invention. At (1), ATF users may create ways to upload test cases to RALLY® via an enterprise ATF 550, such as by uploading test cases via a Linux Command Line Interface (“CLI”) 510 on a server, a native web application 520, and/or an ATF desktop application 530 at (2). At (3), an ATF monolithic framework uses an ATF API to verify environment and/or test case parameters 562 based on a provided parameter configuration at (4). At (5), the ATF API may verify inputs 564 for specific testing types from a DTAaaS capability store and warn user if any inputs are missing (e.g., a missing database type). At (6), The ATF API may upload test scrips 566 to a user provided GITHUB® repository path. At (7), the ATF API may create and/or update a test case 568 in RALLY® if the test case identifier is not available. The ATF API might instead update an existing test case identifier in RALLY® if the identifier is provided with the payload. At (8), the ATF API may upload information to a SNOWFLAKE® AIF event tracking store and/or capture test planning events via TABLEAU® for an ATF event tracking dashboard. At (9), the system may update a test case bulk transfer template with the test case identifier and email the same back to the ATF users as an acknowledgement to the test case upload request.

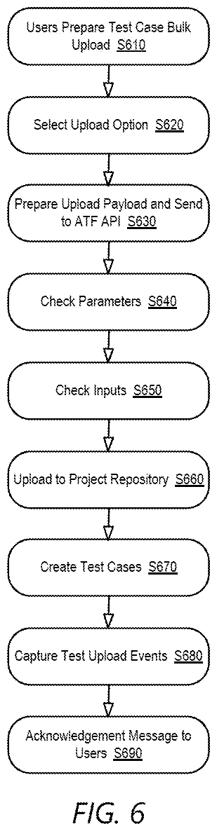

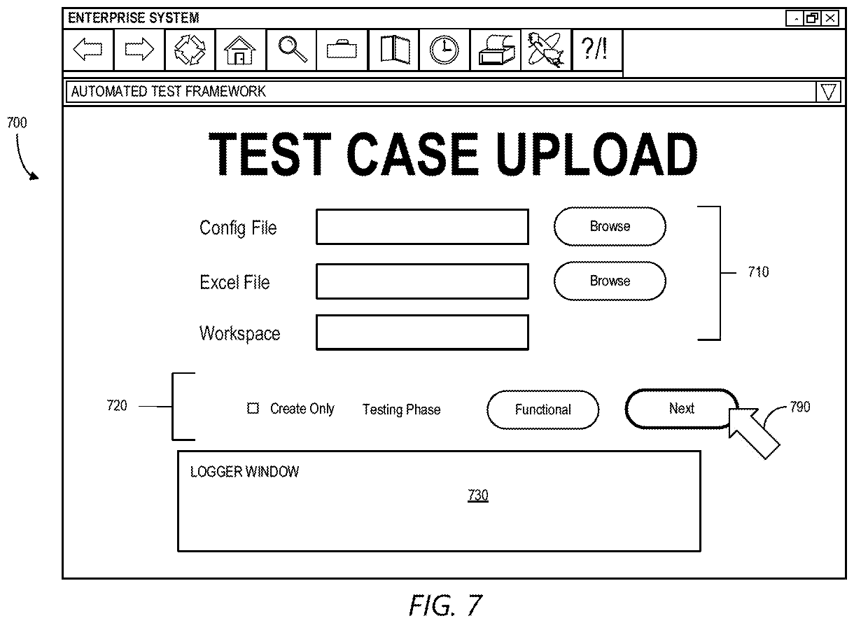

FIG. 6 is a data test planning method in accordance with some embodiments of the present invention. At S610, ATF users prepare a test case bulk upload template within an EXCEL® spreadsheet file. There might be, for example, EXCEL® templates available for each testing capability (or testing type). Users may fill in all of the information related to the data assets under test. Users may also provide information such as the test locators under which the test case should be created, a test case name, a description, and the inputs that are required for the ATF to perform data reconciliation between two data assets. Once the test case bulk upload template is ready, at S620 the user can choose one of the three available options to upload test cases in RALLY®. In a first option, a user may upload test cases via Linux CLI. That is, users can simply log into the server where ATF monolithic code is installed and call the required python script to upload the test cases along with the location of the bulk upload template spreadsheet and/or other available parameters. In a second option, the user may upload test cases via a RALLY native web application just by uploading the test case bulk upload template. In a third option, the user may upload test cases via an ATF desktop application. For example, FIG. 7 is a test case upload display 700 according to some embodiments of the present invention. A user input portion 710 lets a user provide path to test case bulk upload template, a RALLY® workspace name under which test cases needs to be created, and other parameters 720. Selection of a “Next” icon (e.g., via a computer mouse pointer 790) may update the system and a logger window 730 may be updated.

Referring again to FIG. 6, once the inputs are provided, the test case upload payloads may be prepared at S630 and sent to the ATF API for further action. At S640, the ATF API may check if the user provided environment and test case parameters exist in a parameter configuration file. If they are not present, a user warning is generated within the logs. At S650, the ATF API may then check if all the mandatory inputs are available for the ATF to execute. If any inputs are missing, a user warning is generated within logs for the user to investigate. At S660, the ATF API may then upload all of the test scripts to a GITHUB® project repository where they are version controlled. At S670, ATF API may then create test cases within RALLY® under the provided test locators, capture a test case identifier generated by RALLY® and send back a response. If the test case identifiers are already populated within the test case bulk upload template, instead of creating new test cases the ATF may instead update the existing test case identifiers with updated details from the test case bulk upload template. At S680, the test upload events are then captured within a SNOWFLAKE® cloud data warehouse (which will eventually feed ATF event tracking dashboard).

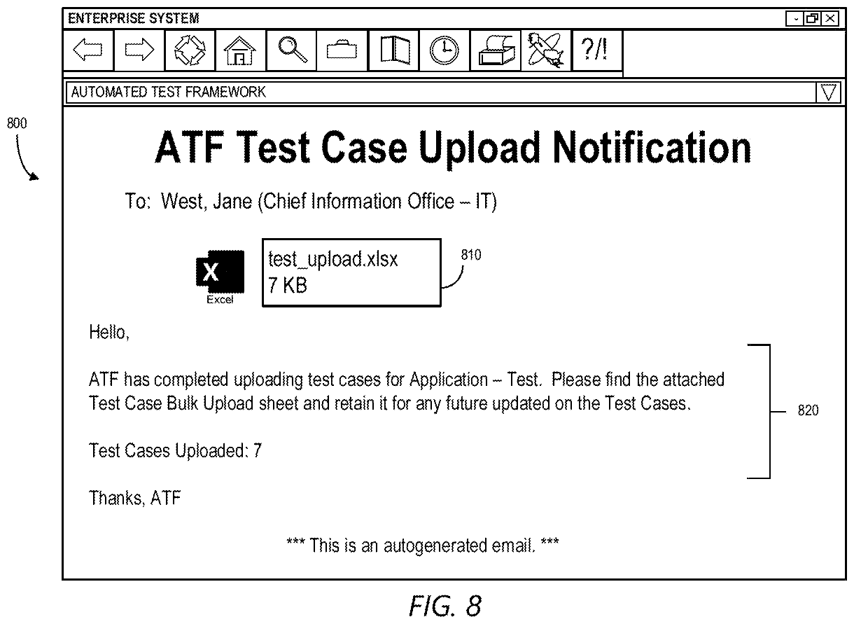

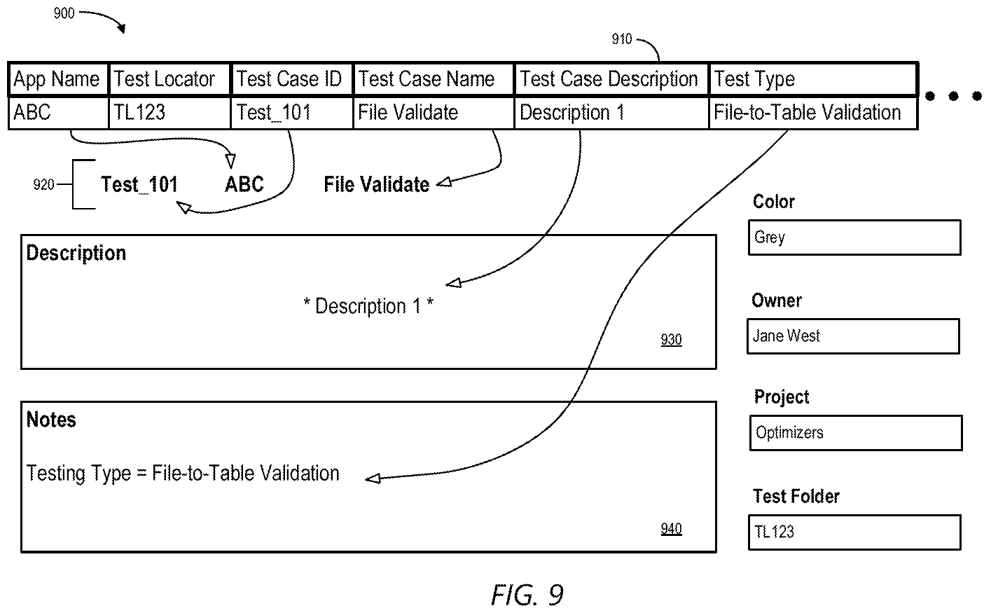

Once all the test case rows are tended to, the updated test case bulk upload template EXCEL® file is sent to the ATF user as an acknowledgement of the activity at S690. For example, FIG. 8 is a test case upload notification message 800 including a test upload attachment 810 and explanation 820 in accordance with some embodiments of the present invention. Users can also validate the test cases created within RALLY® by the ATF. For example, FIG. 9 illustrates 900 creation of a sample test case created from a bulk upload template according to some embodiments of the present invention. Some elements of a record 910 are used to create a header 920 for the test case while other elements are used to generate a test case description 930, test case notes 940, etc.

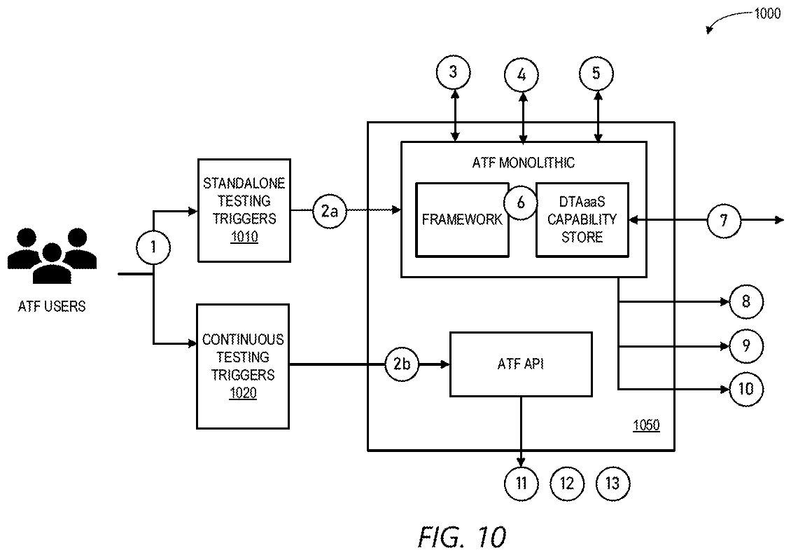

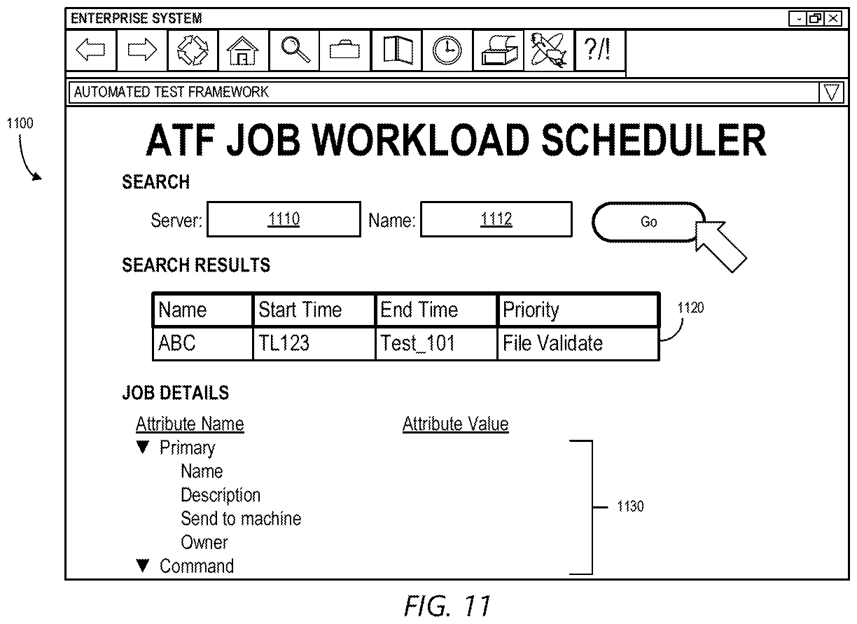

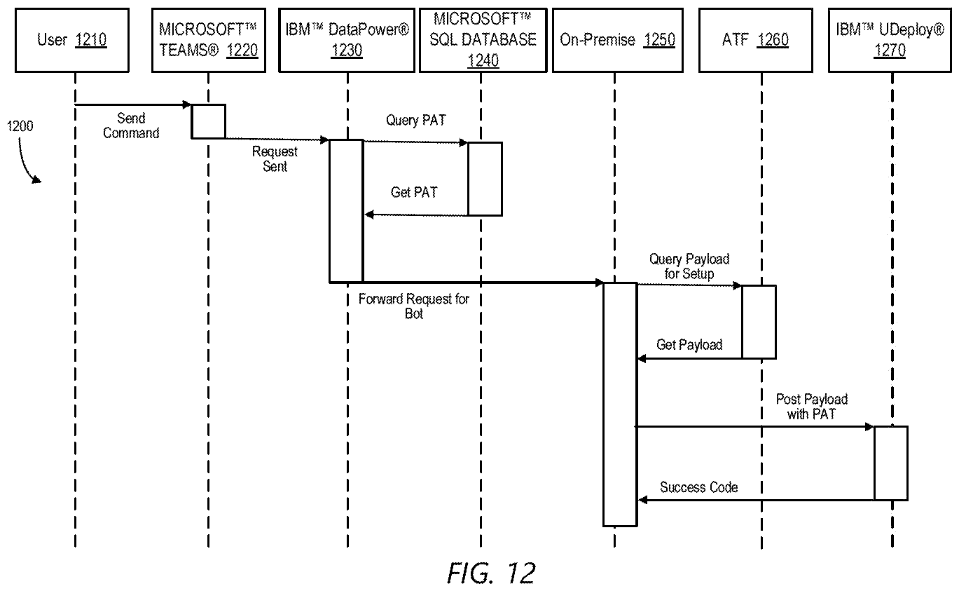

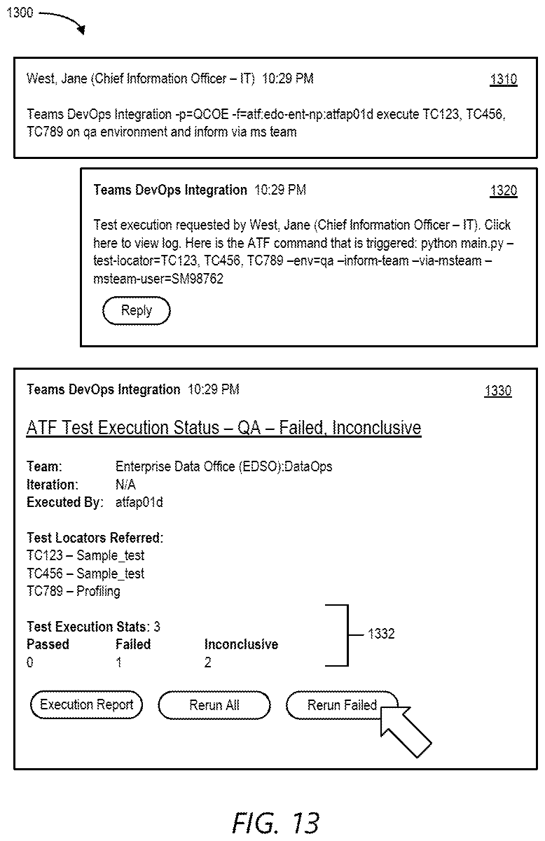

After all of the test cases are uploaded to RALLY and test planning activity is complete, the ATF is now ready to execute those test cases. For example, FIG. 10 is a test execution workflow 1000 in accordance with some embodiments of the present invention. At (1), ATF users establish testing triggers, such as standalone testing triggers 1010 or continuous testing triggers 1020. For standalone testing triggers 1010, at (2a) users can trigger the test execution via an on-demand basis. There are multiple ways to trigger ATF test execution with standalone mode:
Triggered via a Linux CLI on the server: Users log into the server where the ATF monolithic code is installed and call the required python script to execute the test cases along with various Unix argument options.
Trigger by CA Workload Scheduler (Autosys): Users can also choose to create Autosys jobs to execute ATF test cases on a certain time dependency or based on the completion of other batch jobs. Users can also trigger the jobs manually. For example, FIG. 11 is a sample ATF job scheduler display 1100 according to some embodiments of the present invention. The user can search via server 1110 and/or name 1112 and receive search results 1120 and job details 1130.
Trigger ATF via MS Team ChatOps: With the help of a MICROSOFT™ TEAMS® PowerApp BOT, users can trigger an ATF via just by typing a test execution command within a TEAM® channel to trigger the execution. For example, FIG. 12 is a high-level process flow 1200 in accordance with some embodiments of the present invention. A user 1210 sends a command to MICROSOFT® TEAMS® 1220 which then sends a request to IBM™ DataPower® 1230. DataPower® 1230 asks for and receives a Personal Access Token (“PAT”) from MICROSOFT™ SQL DATABASE (e.g., Dataverse®) 1240 and forwards the requests to an on-premise system 1250. The on-premise system 1250 gets the payload for setup from the ATF 1260 and posts the payload with the PAT via IBM™ Urban Code Deploy® or UDeploy® 1270 (which returns a success code). According to some embodiments, this capability of triggering the ATF supports inputs in plain English language. The ATF API may perform Natural Language Processing (“NLP”) or analysis on the inputs provided by the user and extract the inputs useful for triggering ATF. For example, FIG. 13 illustrates 1300 conversion of natural language direction 1310 into a python command line data 1320 according to some embodiments of the present invention. An ATF test execution status message 1330 may then be generated (including test results 1332).
Trigger via a RALLY® native web application: Users can also go to the respective RALLY® project, use the ATF RALLY® native web application, select the test locators to be executed, and click on a “Run” icon to execute the test cases.

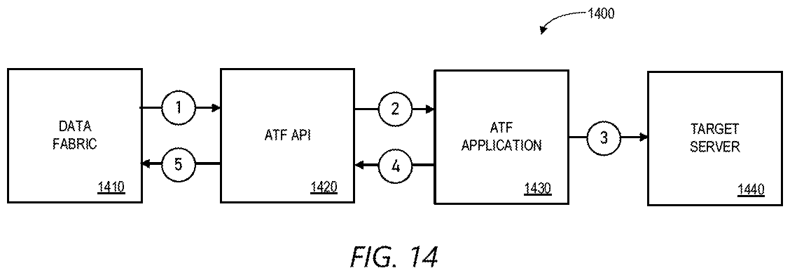

Referring again to FIG. 10, for continuous testing triggers 1020 at (2b) users can trigger the ATF test execution automatically based on completion of data engineering processes. The process might be, for example, a data manufacturing process, load data warehouses, data marts, data lakes, or storing it in a file system. Once the process is completed, ATF API can be called with require inputs:
Trigger via a TALEND® joblet after job completion: In this case, TALEND® may be used to implement Extract, Transform, Load (“ETL”) processes. A TALEND® native ATF joblet is created to be used within ETL job—once the job is completed—the ATF joblet can be called to send request to ATF API, which in turn call an IBM™ UrbanCode Deploy component to initiate the ATF monolithic process on a target server. Upon a successful ATF trigger, the ATF API responds back with IBM UrbanCode Deploy request identifier which can be then used to track the ATF process. For example, FIG. 14 is a continuous testing workflow 1400 in accordance with some embodiments of the present invention. At (1), a data fabric (e.g., TALEND®) 1410 may post data load components and an ATF joblet is called to initiate data validation. At (2), the joblet sends the request to the ATF API 1420 with test execution arguments and target server 1440 information causing an ATF application 1430 to trigger UDeploy components to begin test execution on the target server 1440 at (3) (e.g., edge nodes). UDeploy response back with a request identifier at (4) and the ATF API 1420 sends the request identifier and log URL to the joblet at (5).
Trigger via ATF API request: If projects are using any other data engineering technology stack, they can still send an ATF API request to initiate ATF test execution on the target server via IBM UrbanCode Deploy component.

Referring again to FIG. 10, at (3), the ATF 1050 may fetch test cases for test locators from RALLY®, and at (4) it may pull relevant test scripts from a GITHUB® repository. At (5), the ATF 1050 may perform environment and test cast level parameter resolution for test cases. At (6), the framework and DTAaaS capability store may communicate to store objects under test/profiling at (7) (e.g., sources and targets). At (8), rest results may be uploaded to RALLY® and defect management may be performed at (9). At (10), a test execution status notification may be sent to ATF users. At (11), a SNOWFLAKE® event tracking data store may be updated which can lead to ATF test and event information being updated at (12) for dashboard support and predictive model training may be performed at (13) to provide automated support (e.g., advising an ATF user about how an inconsistent result might be corrected).

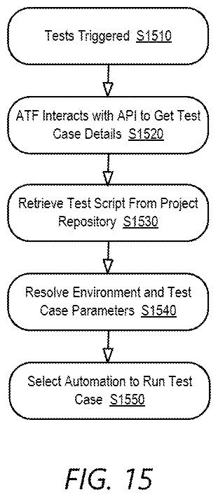

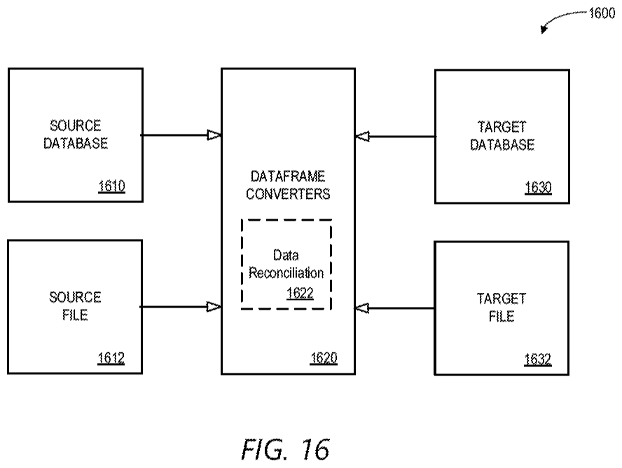

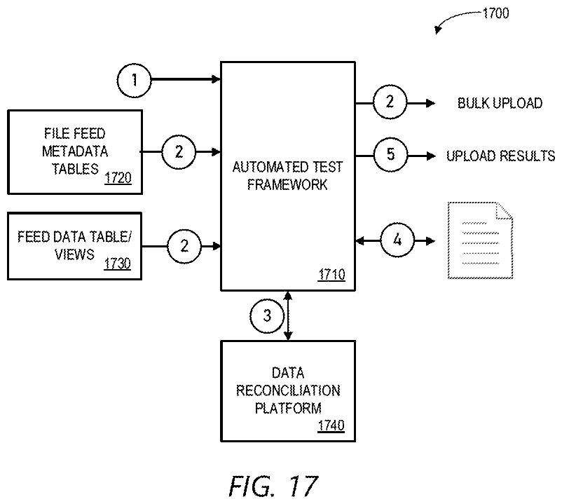

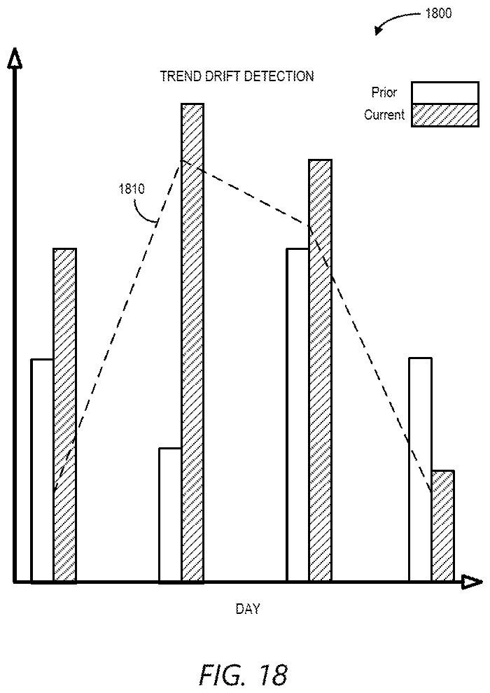

FIG. 15 is a test execution method according to some embodiments of the present invention. When tests are triggered at S1510, the ATF may interact with the API to get test case details at S1520. For example, Once the ATF monolithic code is triggered with user provided inputs, the ATF may start interacting with RALLY® API to get the details about the test cases that exist under the supplied test locators. When all the test case details are retrieved, the ATF starts execution of the test cases with multi-threading (e.g., limiting to five simultaneous threads). For each test case, the ATF may reach out to A GITHUB® project repository at S1530 to retrieve test scripts that were uploaded at the time of test planning. After the test scripts are retrieved, at S1540 the ATF resolves environment and test case parameters. Environment parameters let test cases be executed across environments (e.g., “QA”, “production,” etc.) without modifying the test cases. Test case parameters may let the same test case be executed with different inputs (without duplicating effort). When all of the parameters are resolved and the inputs are acquired for the test case, the framework may reach out to the DTAaaS capability store at S1550 to select the appropriate automation and execute the test case. Each test case may be assigned a testing type at the time of test planning. The ATF may have a test automation capability assigned to execute each testing type. Some capabilities that might be available within ATF DTAaaS capability store include:
ATF Generic Components: These are basic building blocks of the test automation capabilities might include database connectors, dataframe convertors, data reconciliation platforms, and Bring Your Own Data Test Automation (“BYODA”) hooks. According to some embodiments, data validation may be supported for various databases such as HIVE, ORACLE®, PostGre, SQL Server, SNOWFLAKE®, DB2 AS400, etc. Data validation might also be supported for various file Formats, such as XML, JSON, AVRO, CSV, delimited flat files, fixed width flat files, Parquet, EXCEL®, etc.
SQL validations may be supported for Hive, ORACLE®, SQL Server, Snowflake, DB2 AS400, Postgre, flat file, EXCEL®, etc.
DDL and/or metadata validations may be supported (e.g., for Hive, ORACLE®, SQL Server, SNOWFLAKE®, and Postgre)
Data reconciliation with Pandas and PySpark might be supported. For example, FIG. 16 illustrates ATF data reconciliation capabilities 1600 in accordance with some embodiments of the present invention. Source database 1610 and source file 1612 and target database 1630 and target file 1632 may interact with dataframe converters 1620. The dataframe converters 1620 may then perform data reconciliation 1622.
Spark SQL based data ingestion validation
File feed validation such as the one illustrated 1700 in FIG. 17 according to some embodiments of the present invention. At (1), the system may prepare a bulk upload test case template for file feed validation (e.g., file feed location, feed title, environment, etc.). At (2) file feed metadata tables 1720 and feed data table/views 1730 may be provided to the automated test framework to support the bulk upload to RALLY®. At (3), the ATF 1710 exchanges information with a data reconciliation platform 1740 to perform a data comparison. At (4), the generated feed file under test may be updated and the results may be stored to RALLY® at (5).
Table to table count validations
Trend drift detection may identify a percentage change of deviation from expected values between prior and current day metrics. For example, FIG. 18 illustrates 1800 trend drift detection in accordance with some embodiments of the present invention where a trend over time 1810 may be determined.
JSON structure validation
Kafka data streaming validation automation
Data quality checks may be supported, such as: a missing value check, a valid value check, a referential check, a primary key check, a row duplicate check, a business rule, an email validation, a date of birth validation, a SSN validation, an employee identification number validation, a ZIP or postal code validation, a state code validation, etc.

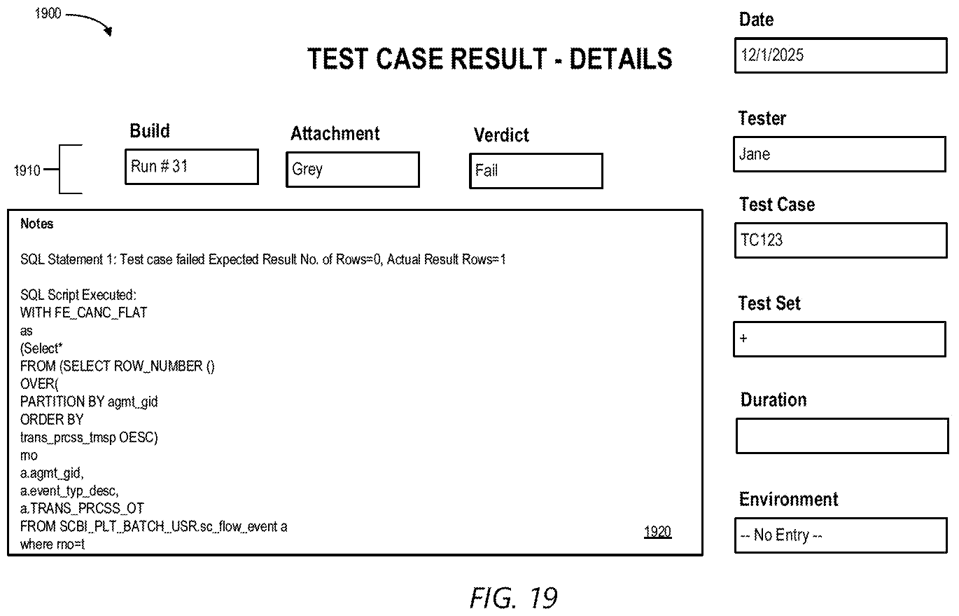

The DTAaaS automations reach out to the data assets under test, execute the validation automation, and derive test results. The results might be, for example, pass, fail, or inconclusive. An “inconclusive” test result might mean that an exception occurred during automation execution. The result status and all the related notes may then be supplied back to the framework. The ATF can then create results within RALLY® under the respective test case, mark the result status, and upload the result notes. If notes are longer than a pre-determined length (e.g., more than 5000 characters), they may be stored in a text file and attached to the RALLY® results. FIG. 19 is a sample result 1900 created by an ATF according to some embodiments of the present invention. The result 1900 includes test case identification information 1910 and notes 1920 about the test case details.

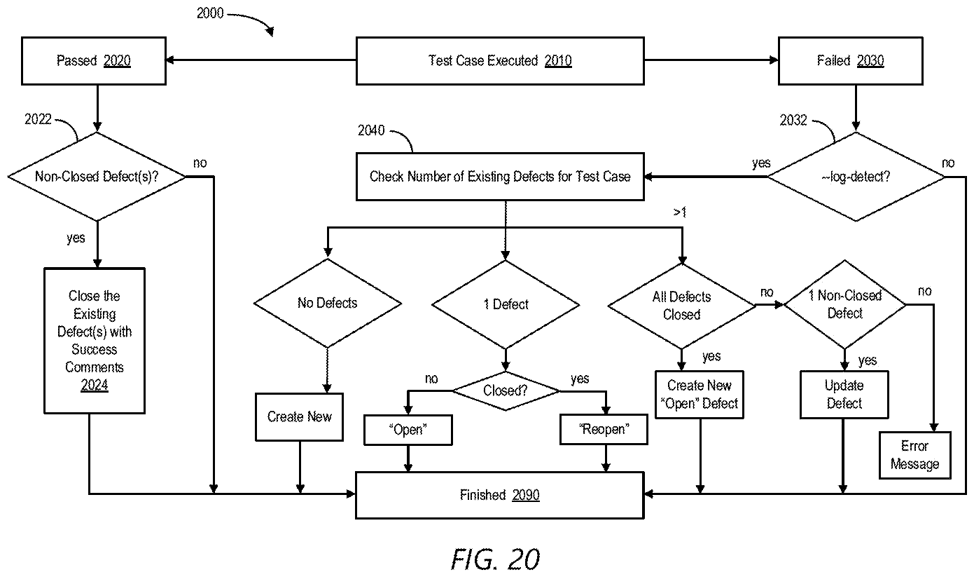

If a test case is failed, based on user preferences, the ATF may also create a RALLY® defect so that it can be prioritized and fixed. In this way, the ATF may implement a defect management process during execution. For example, FIG. 20 is an ATF defect management process 2000 in accordance with some embodiments of the present invention. If, after execution of the test case 2010 it is determined that the test case passed 2020, it is determined if any defects for that test case exist with a “non-closed” status 2022. If not, the process 2000 is finished 2090. If a defect exists, it is closed with success comment 2024 and the process 2000 is finished.

If, after execution of the test case 2010 it is determined that the test case failed 2030, it is determined if a −−log-defect argument was specified for the test case 2032. If not, the process 2000 is finished 2090. If it is determined that a −−log-defect argument was specified for the test case 2032, the system checks the number of existing defects for the test case 2040. If no defects exist, one is created and the process 2000 is finished 2090. If a single open defect exists, the defect is updated with an “open” status and the process 2000 is finished 2090. If a single closed defect exists, the defect is updated with an “re-open” status and the process 2000 is finished 2090. If there are multiple defects and all existing defects are already closed, a new defect is created with “open” status and the process 2000 is finished 2090. If multiple defects exist and at least one non-closed defect is available, it is updated with “open” or “re-open” status and the process 2000 is finished 2090. If multiple defects exist and no non-closed defect is available, the ATF cannot determine which defect to update, so an error message is generated and the process 2000 is finished 2090.

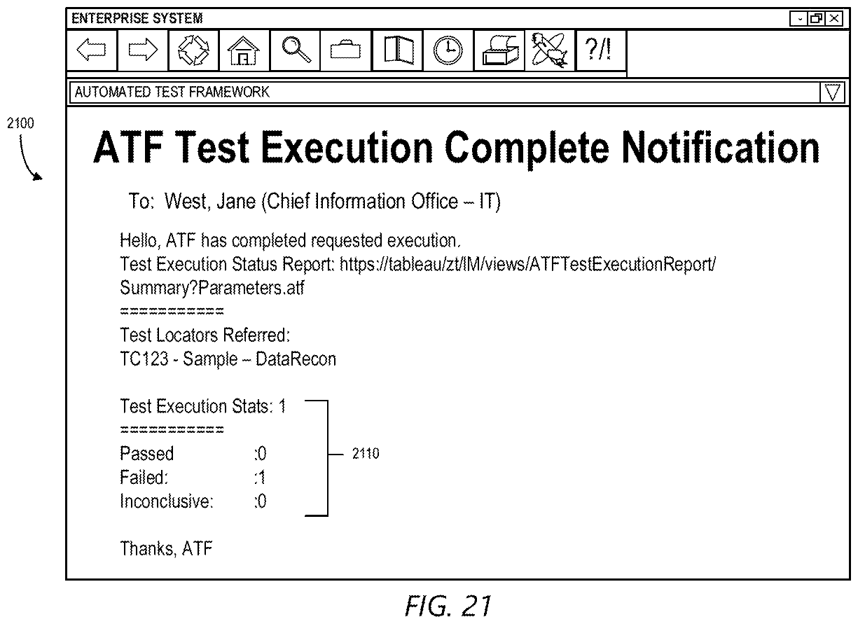

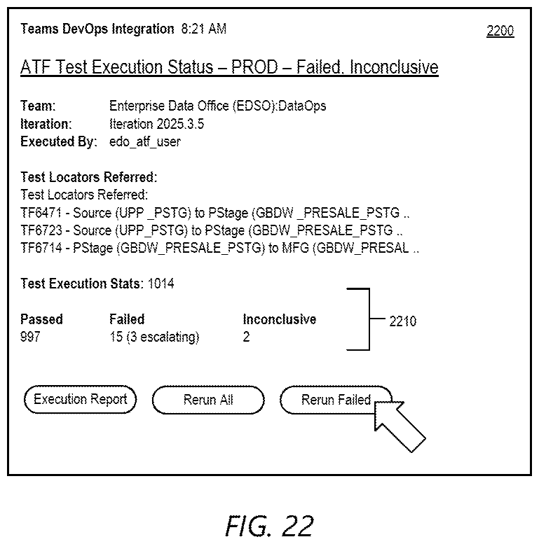

After all of the underlined test cases for the provided test locators are executed, the ATF transmits a test execution notification. Based on a user preference, the test execution notification might be sent via email or a MICROSOFT™ TEAMS® channel card. For example, FIG. 21 is a test execution notification email message 2100 including test results 2110 according to some embodiments of the present invention. FIG. 22 is a test execution notification channel card 2200 including test results 2210 according to some embodiments of the present invention. The card 2200 may also have links to an execution report and quick execution buttons to rerun all of the test cases or to rerun only the failed ones.

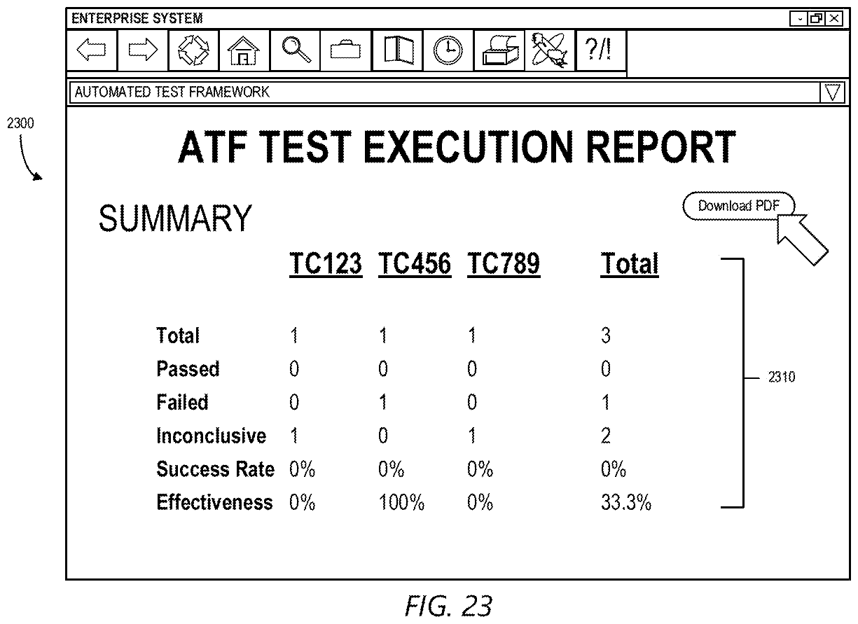

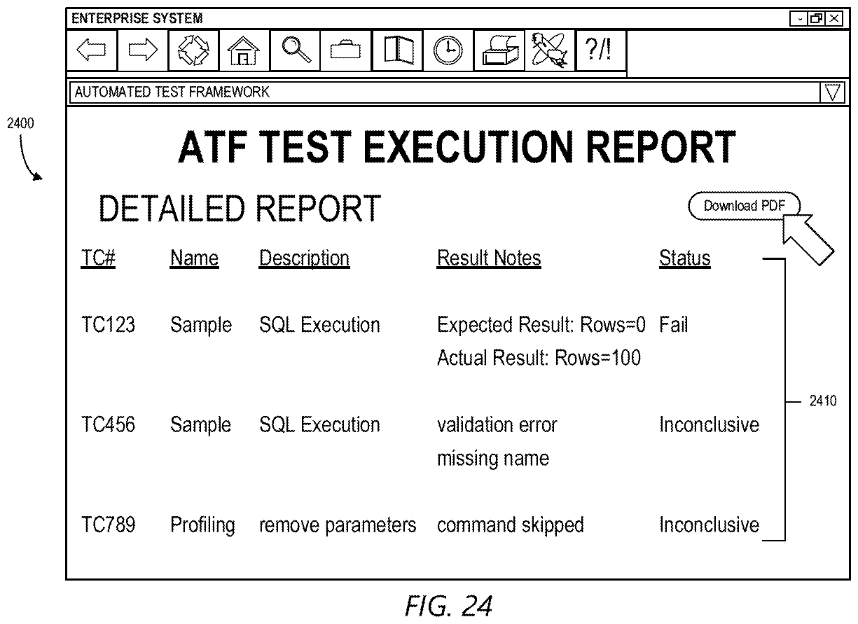

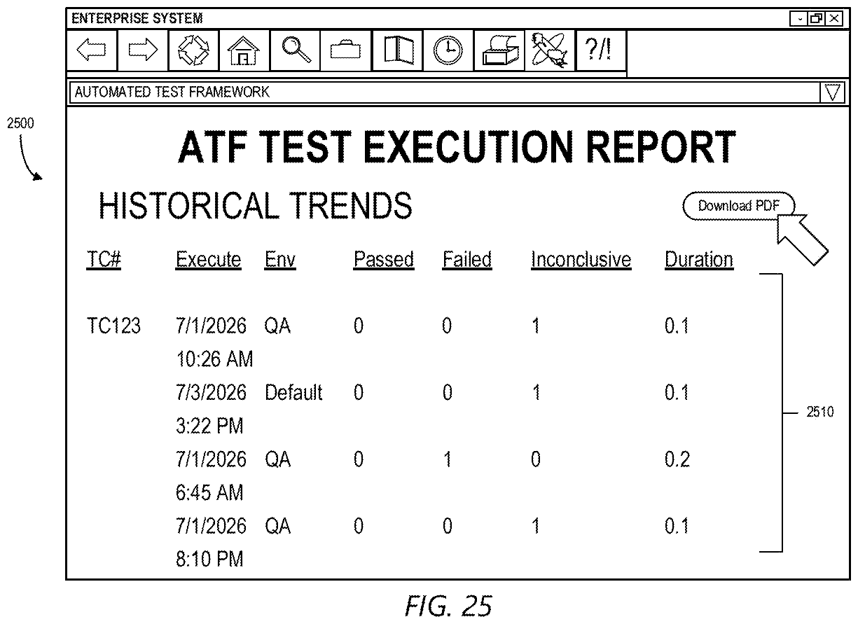

The ATF may, according to some embodiments, also persist the execution related data within a SNOWFLAKE® cloud data warehouse. The SNOWFLAKE® cloud data warehouse data may then be utilized for ATF a test execution status dashboard and/or an ATF event tracking dashboard. For example, FIG. 23 is a test execution report display 2300 according to some embodiments of the present invention. The display 2300 includes a summary of test results 2310 for various test cases, including a success rate and an effectiveness score. According to some embodiments, the display 2300 might further include a “download” icon to generate a pdf report, a graphical display by status, testing type, or test locator, average run time information, etc. FIG. 24 is a detailed report display 2400 in accordance with some embodiments of the present invention. The display 2400 includes details about each test case 2410 including a case name, description, and result notes. FIG. 25 is a historical trend display 2500 according to some embodiments of the present invention. The display 2500 includes information for a test case over a period of time 2510 (e.g., to help a user identify cases that are experiencing prolonged or increasing failures.

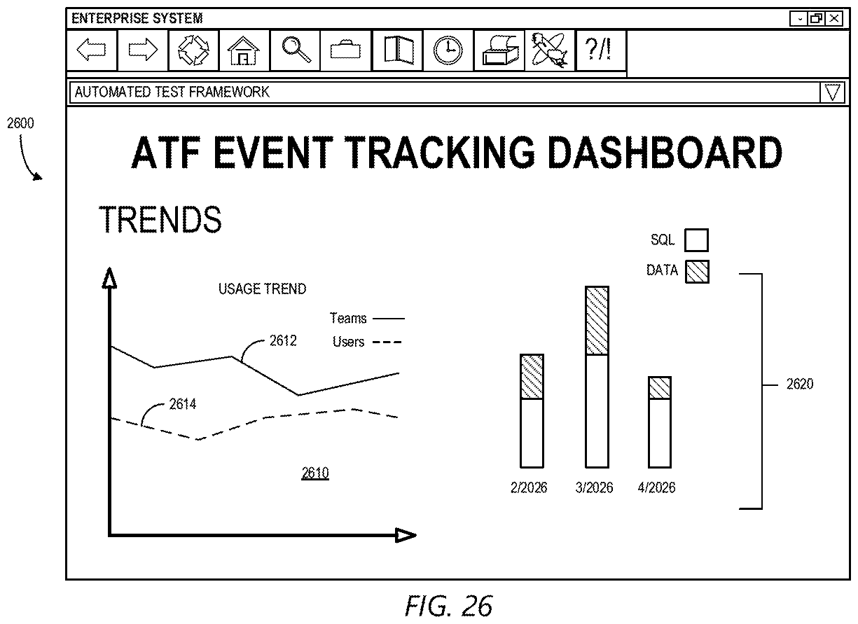

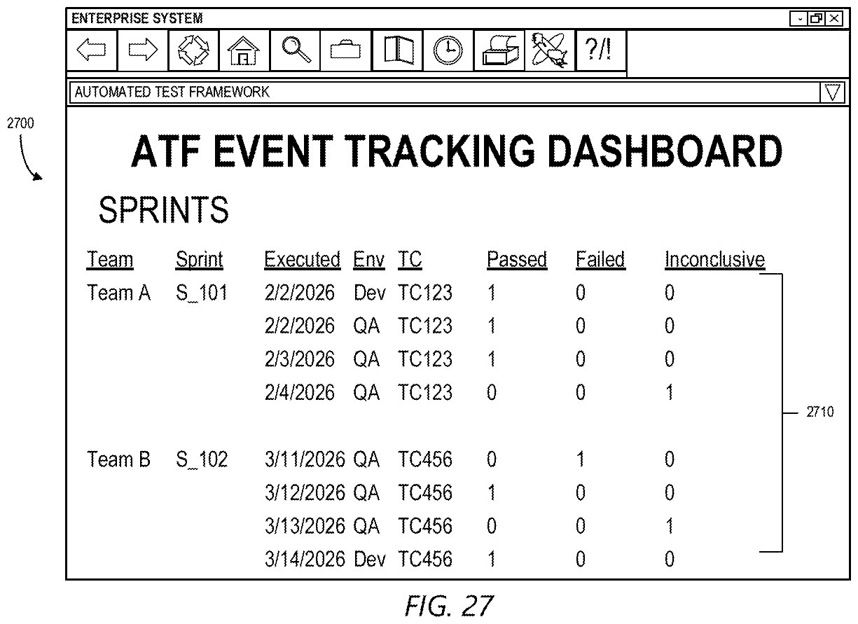

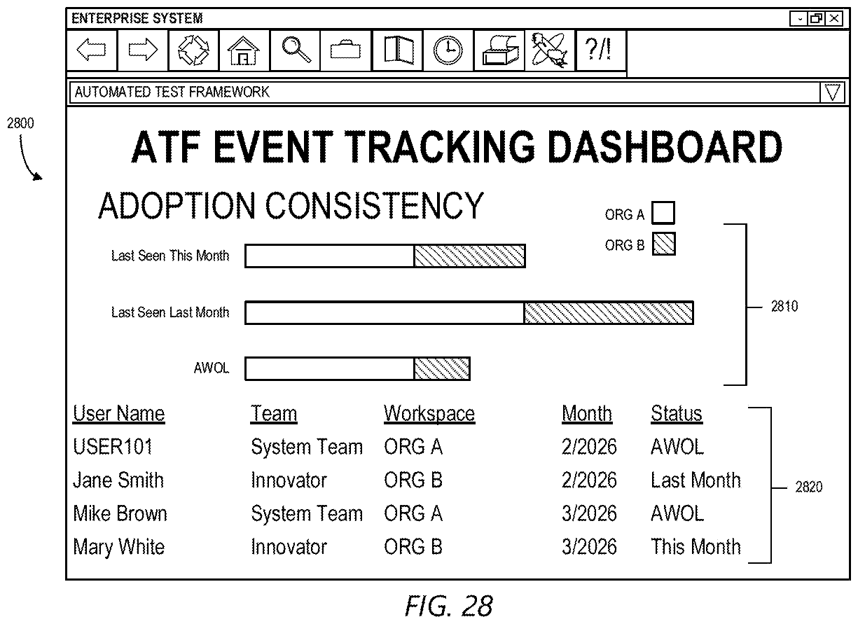

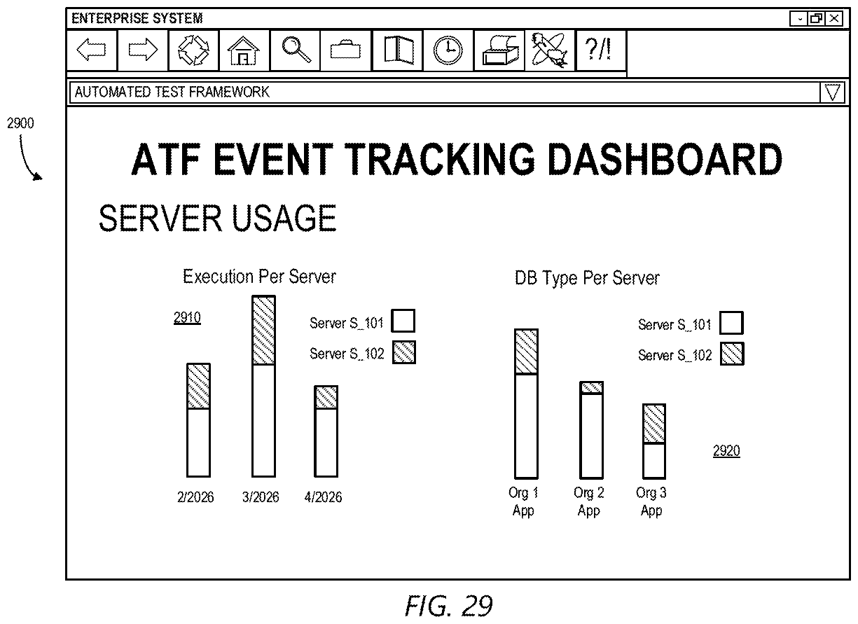

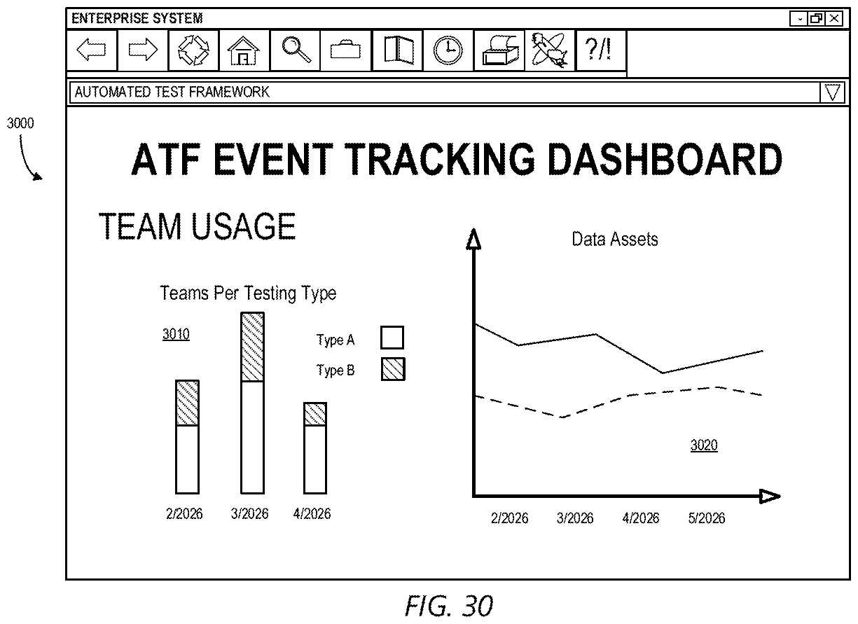

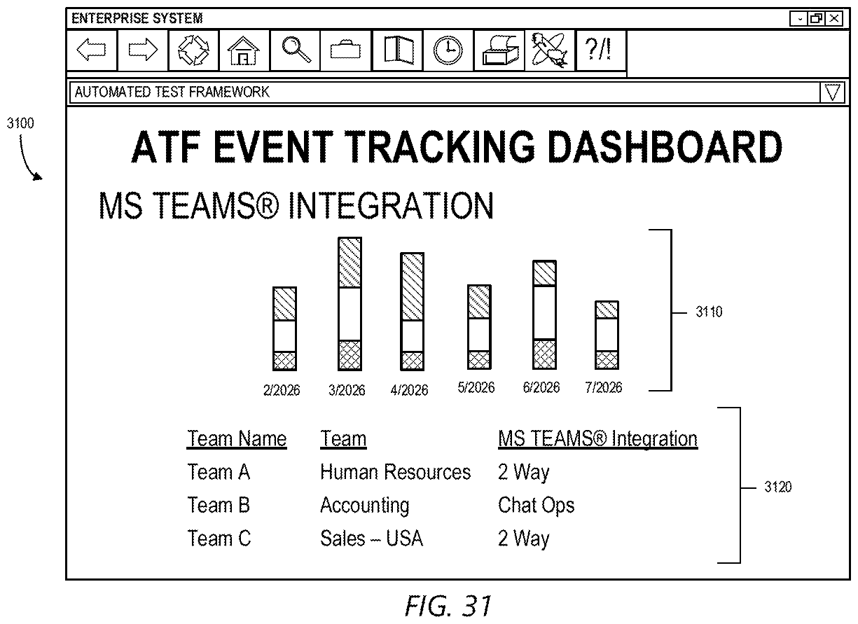

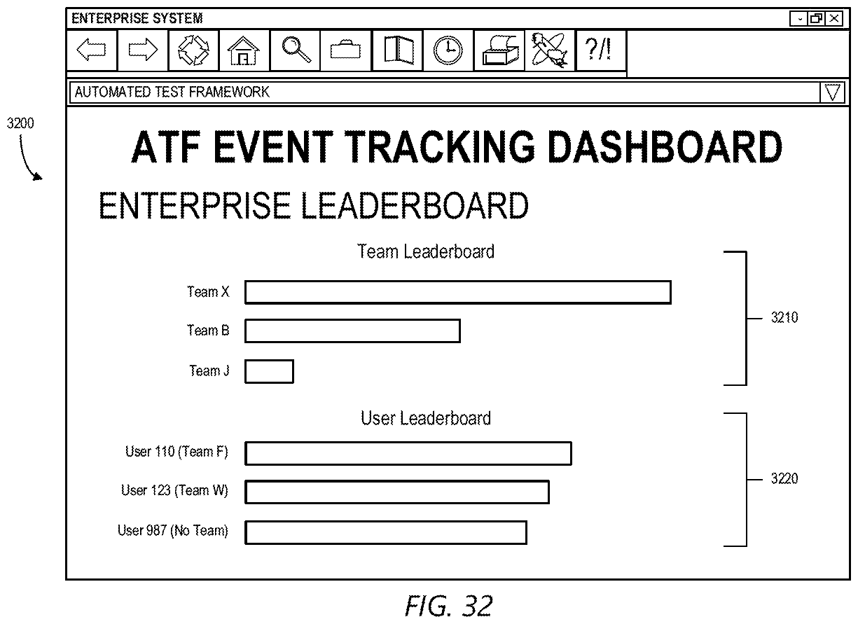

The ATF platform may also support event tracking dashboards. For example, FIG. 26 is a trend display 2600 in accordance with some embodiments of the present invention. The display 2600 shows a usage trend over time 2610 (e.g., for teams 2612 and users 2614) and a graphical representation of test case types 2620. According to some embodiments, the display 2600 may further include information about activity trends (e.g., for test cases planned, unique test case executions, and test case runs). FIG. 27 is a sprint display 2700 that summarizes team sprints 2710 according to some embodiments of the present invention. FIG. 28 is an adoption consistency display 2800 showing when various users have accessed the system 2810 and details about the access 2820 (similar information could be provided on a per team basis) in accordance with some embodiments of the present invention. FIG. 29 is a server usage display 2900 shown executions per server 2910 and database types per server 2920 according to some embodiments of the present invention (similar information could be provided for teams per server, non-qualified ATF paths, etc.). FIG. 30 is a team usage display 3000 showing terms per testing type 3010 and data assets over time 3020 in accordance with some embodiments of the present invention (similar information could be provided about test design effectiveness). FIG. 31 is a MICROSOFT™ TEAMS® integration adoption display 3100 showing graphical 3110 and detailed 3120 about the level of TEAMS® integration according to some embodiments of the present invention. FIG. 32 is an enterprise leaderboard display 3200 showing a team leaderboard 3210 and a user leaderboard 3220 in accordance with some embodiments of the present invention.

According to some embodiments, the SNOWFLAKE event tracking data is also used for training a predictive model to automate support for ATF users who faced exceptions for various reasons while executing tests via ATF. The model may help users with proactive support when a known issue occurs during test execution, thus reducing the overall effort and time taken by ATF administration team to resolve every issue.

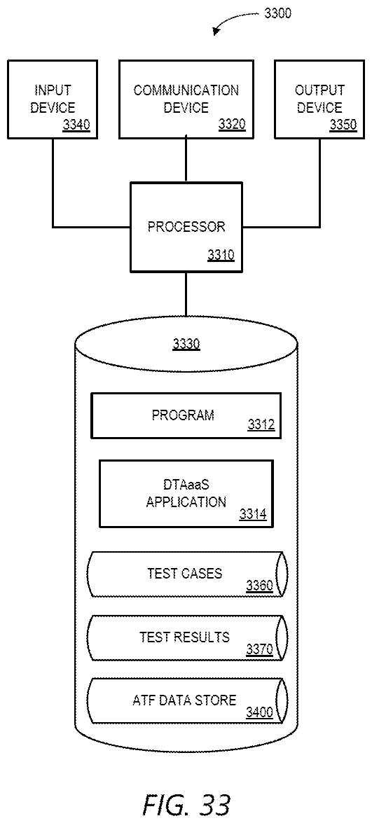

The embodiments described herein may be implemented using any number of different hardware configurations. For example, FIG. 33 illustrates an ATF platform 3300 that may be, for example, associated with the system 100 of FIG. 1. The ATF platform 3300 comprises a processor 3310, such as one or more commercially available Central Processing Units (“CPUs”) in the form of one-chip microprocessors, coupled to a communication device 3320 configured to communicate via a communication network (not shown in FIG. 33). The communication device 3320 may be used to communicate, for example, with one or more remote devices. The ATF platform 3300 further includes an input device 3340 (e.g., a mouse and/or keyboard to enter test or data information or associated adjustments) and an output device 3350 (e.g., a computer monitor to display an ATF result and/or execution notes).

The processor 3310 also communicates with a storage device 3330. The storage device 3330 may comprise any appropriate information storage device, including combinations of magnetic storage devices (e.g., a hard disk drive), optical storage devices, mobile telephones, and/or semiconductor memory devices. The storage device 3330 stores a program 3312 and/or an DTAaaS application 3314 for controlling the processor 3310. The processor 3310 performs instructions of the programs 3312, 3314, and thereby operates in accordance with any of the embodiments described herein. For example, the processor 3310 may receive, from a user, data test planning information that defines a test case. The ATF platform may interpret API information to implement a DTAaaS and detect a trigger event that initiates a test execution associated with the test case. In some embodiments, information about the test case is stored via a third-party enterprise team planning system and/or hosting service for software development and version control. Responsive to the detected trigger, the processor 3310 may automatically arrange to execute the test case via the DTAaaS. A test result of the executed test case may then be output by the processor 3310 (e.g., pass, fail, or inconclusive).

The programs 3312, 3314 may be stored in a compressed, uncompiled and/or encrypted format. The programs 3312, 3314 may furthermore include other program elements, such as an operating system, a database management system, and/or device drivers used by the processor 3310 to interface with peripheral devices.

As used herein, information may be “received” by or “transmitted” to, for example: (i) the ATF platform 3300 from another device; or (ii) a software application or module within the ATF platform 3300 from another software application, module, or any other source.

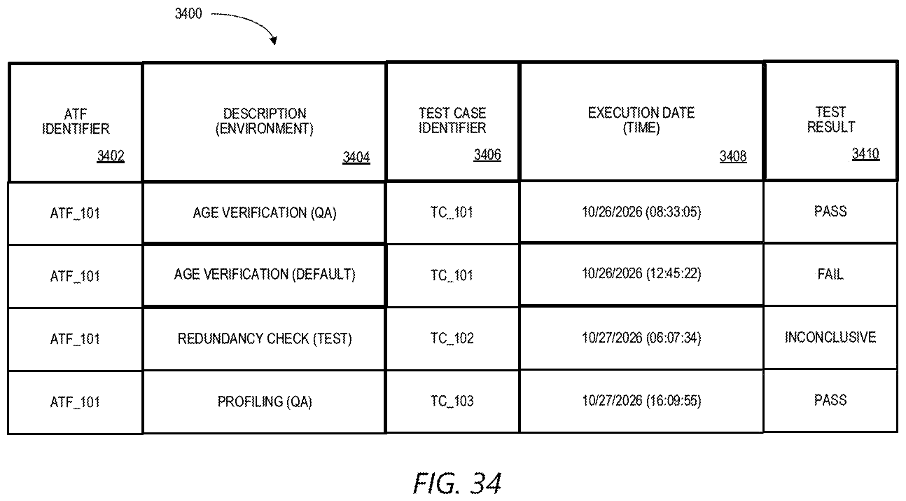

In some embodiments (such as shown in FIG. 33), the storage device 3330 stores test case database 3360 (e.g., defining test cases to be executed), a test results database 3370 (e.g., storing the results of test case executions), and an ATF data store 3400. An example of a database that may be used in connection with the ATF platform 3300 will now be described in detail with respect to FIG. 34. Note that the database described herein is only one example, and additional and/or different information may be stored therein. Moreover, various databases might be split or combined in accordance with any of the embodiments described herein.

Referring to FIG. 34, a table is shown that represents the ATF data store 3400 that may be stored at the ATF platform 3300 according to some embodiments. The table may include, for example, entries identifying test case executions. The table may also define fields 3402, 3404, 3406, 3408, 3410 for each of the entries. The fields 3402, 3404, 3406, 3408, 3410, may, according to some embodiments, specify: an ATF identifier 3402, a test case description and environment 3404, test case identifier 3406, an execution date and time 3408, and a test result 3410. The information in the ATF data store 3400 may be created and updated, for example, based on information received via RALLY® and/or GITHUB®.

The ATF identifier 3402 may be, for example, a unique alphanumeric code identifying a particular ATF platform. The test case description and environment 3404 might identify the purpose of the test case, and the test case identifier 3406 may link to particular information in RALLY® and/or GITHUB®. The execution date and time 3408 might indicate when the test case was executed and the test result 3410 might indicate if the execution passed, failed, or was inconclusive.

Thus, some embodiments may provide improved ways to facilitate automated testing for an enterprise data application layer.

The following illustrates various additional embodiments of the invention. These do not constitute a definition of all possible embodiments, and those skilled in the art will understand that the present invention is applicable to many other embodiments. Further, although the following embodiments are briefly described for clarity, those skilled in the art will understand how to make any changes, if necessary, to the above-described apparatus and methods to accommodate these and other embodiments and applications.

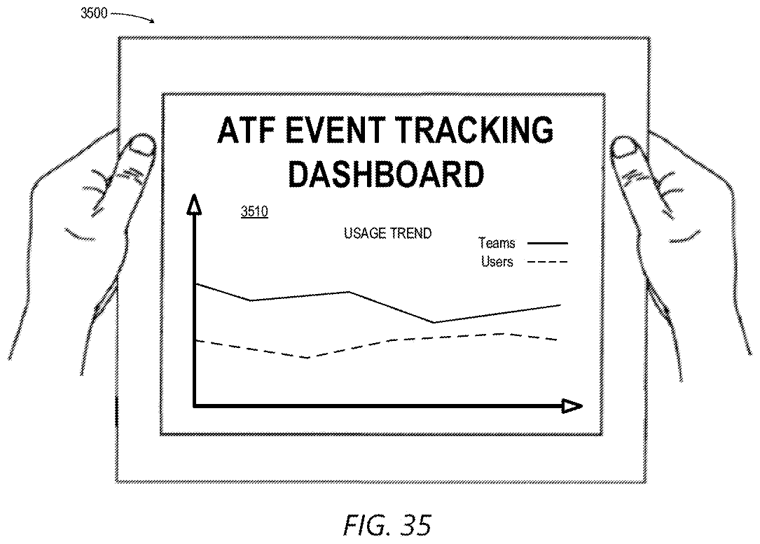

Although specific hardware and data configurations have been described herein, note that any number of other configurations may be provided in accordance with embodiments of the present invention (e.g., some of the information associated with the databases described herein may be combined or stored in external systems). Moreover, the various displays have been provided only as examples and other display could be similarly supported. For example, FIG. 35 illustrates a handheld tablet display 3500 in accordance with some embodiments. The display 3500 includes a graphical representation of an ATF event tracking dashboard 3510.

What is claimed:

1. A system to facilitate automated testing for an enterprise data application layer, comprising:
an Automated Testing Framework (“ATF”) platform, including:
a computer processor for executing program instructions; and
a memory, coupled to the computer processor, for storing program instructions that, when executed by the computer processor, cause the ATF platform to:
(i) during a test design phase, receive, from a user, data test planning information that defines a test case and store information via a third-party enterprise team planning system,
(ii) during a test execution phase, detect a trigger event, from a user or a system, that initiates a test execution associated with the test case,
(iii) receive test execution information to be referred from the third-party enterprise team planning system,
(iv) refer a Data Test Automation-as-a-Service (“DTAaaS”) capability from a DTAaaS capability store to execute data test scenarios,
(v) determine test results for the executed test case scenarios and store them within the third-party enterprise team planning system,
(vi) generate predictive modeling-based help suggestions to resolve exceptions encountered during test execution,
(vii) perform defect management within the third-party enterprise team planning system, and
(viii) generate a user notification via a third-party enterprise communication platform.

2. The system of claim 1, wherein the DTAaaS capability store holds test automation capability for various test scenarios.

3. The system of claim 1, wherein the data test planning information received from the user includes information about at least one of: (i) test script design, (ii) test plan creation, (iii) a bulk upload template, (iv) a spreadsheet application record, (v) a test locator, (vi) a test case name, (vii) a test case description, and (viii) test case inputs.

4. The system of claim 1, wherein each test result comprises one of: (i) pass, (ii) fail, and (iii) inconclusive.

5. The system of claim 1, wherein information about the test case is stored via a third-party hosting service for software development and version control.

6. The system of claim 1, wherein information about the test case is automatically verified via the ATF API.

7. The system of claim 6, wherein the verification is associated with at least one of: (i) a test environment, (ii) test parameters, (iii) missing inputs.

8. The system of claim 1, wherein user notification is automatically transmitted to the user.

9. The system of claim 1, wherein the trigger event comprises at least one of: (i) a standalone testing trigger, (ii) a command line interface trigger, (iii) a workload scheduler trigger, (iv) a third-party enterprise communication platform chat trigger, (v) a third-party enterprise team planning system trigger, (vi) a continuous testing trigger, (vii) an ATF API trigger, and (viii) natural language processing.

10. The system of claim 1, wherein said arranging to execute the test case via the DTAaaS includes at least one of: (i) database conversion, (ii) file format conversion, (iii) data ingestion validation, (iv) file feed validation, (v) table-to-table count validation, (vi) trend drift detection, (vii) JavaScript Object Notation (“JSON”) structure validation, (viii) data quality checks, (ix) data reconciliation across heterogeneous data platforms including data stores and file systems, and (x) data profiling.

11. The system of claim 1, wherein the ATF platform further provides a dashboard display to the user, the dashboard display including at least one of: (i) a test execution report, (ii) a test execution summary, (iii) a detailed report, (iv) historical trends, (v) sprint information, (vi) adoption consistency, (vii) server usage, (viii) team usage, and (ix) an enterprise leaderboard.

12. A computer-implemented method to facilitate automated testing for an enterprise data application layer, comprising:
receiving, during a test design phase from a user at a computer processor of an Automated Testing Framework (“ATF”) platform, data test planning information that defines a test case;
storing, during the test design phase, the data test planning information via a third-party enterprise team planning system;
during a test execution phase, detecting a trigger event, from a user or a system, that initiates a test execution associated with the test case;
receiving test execution information to be referred from the third-party enterprise team planning system;
referring a Data Test Automation-as-a-Service (“DTAaaS”) capability from a DTAaaS capability store to execute data test scenarios;
determining test results for the executed test case scenarios and storing them within the third-party enterprise team planning system;
generating predictive modeling-based help suggestions to resolve exceptions encountered during test execution;
performing defect management within the third-party enterprise team planning system; and
generating a user notification via a third-party enterprise communication platform.

13. The method of claim 12, wherein the DTAaaS capability store holds test automation capability for various test scenarios.

14. The method of claim 12, wherein the data test planning information received from the user includes information about at least one of: (i) test script design, (ii) test plan creation, (iii) a bulk upload template, (iv) a spreadsheet application record, (v) a test locator, (vi) a test case name, (vii) a test case description, and (viii) test case inputs.

15. The method of claim 12, wherein each test result comprises one of: (i) pass, (ii) fail, and (iii) inconclusive.

16. The method of claim 12, wherein information about the test case is stored via a third-party hosting service for software development and version control.

17. The method of claim 12, wherein information about the test case is automatically verified via the ATF API.

18. The method of claim 17, wherein the verification is associated with at least one of: (i) a test environment, (ii) test parameters, (iii) missing inputs.

19. A non-transitory computer-readable medium storing instructions adapted to be executed by a computer processor to perform a method to facilitate automated testing for an enterprise data application layer, the method comprising:
receiving, from a user at a computer processor of an Automated Testing Framework (“ATF”) platform, data test planning information that defines a test case;
interpreting Application Programming Interface (“API”) information to implement a Data Test Automation-as-a-Service (“DTAaaS”);
detecting a trigger event that initiates a test execution associated with the test case;
responsive to the detected trigger, automatically arranging to execute the test case via the DTAaaS; and
outputting a test result of the executed test case.

20. The medium of claim 19, wherein a test case creation notification is automatically transmitted to the user.

21. The medium of claim 19, wherein the trigger event comprises at least one of: (i) a standalone testing trigger, (ii) a command line interface trigger, (iii) a workload scheduler trigger, (iv) a third-party enterprise communication platform chat trigger, (v) a third-party enterprise team planning system trigger, (vi) a continuous testing trigger, (vii) an ATF API trigger, and (viii) natural language processing.

22. The medium of claim 19, wherein said arranging to execute the test case via the DTAaaS includes at least one of: (i) database conversion, (ii) file format conversion, (iii) data ingestion validation, (iv) file feed validation, (v) table-to-table count validation, (vi) trend drift detection, (vii) JavaScript Object Notation (“JSON”) structure validation, (viii) data quality checks, (ix) data reconciliation across heterogeneous data platforms including data stores and file systems, and (x) data profiling.

23. The medium of claim 19, wherein the ATF platform further provides a dashboard display to the user, the dashboard display including at least one of: (i) a test execution report, (ii) a test execution summary, (iii) a detailed report, (iv) historical trends, (v) sprint information, (vi) adoption consistency, (vii) server usage, (viii) team usage, and (ix) an enterprise leaderboard.
